(19) United States
(12) Patent Application Publication
(10) Pub. No.: US 2009/0222318 A1
(43) Pub. Date: Sep. 3, 2009

(54) METHOD, SYSTEM AND KIOSK FOR CONNECTING A CUSTOMER TO AN EXPERT AT A REMOTE LOCATION

(75) Inventors: Nolan Anelevitz, Toronto (CA); Lowell Wintrup, Toronto (CA)

Correspondence Address: BERESKIN AND PARR LLP/S.E.N.C.R.L., s.r.l., 40 KING STREET WEST, BOX 401, TORONTO, ON, M5H 3Y2, CA

(73) Assignee: FASTRAK ISP INC., Toronto (CA)

(21) Appl. No.: 12/040,175

(22) Filed: Feb. 29, 2008

(51) Int. Cl. G06F 17/30; G06Q 30/00

(52) U.S. Cl. 705/10; 705/14; 705/1

(57) ABSTRACT

An interactive kiosk is provided and an interactive customer information system that uses same is provided. The kiosk may have at least one an output module to provide a document controlled by a person at a remote location and the ability to display two video images simultaneously.

### TECHNICAL FIELD

The described embodiments relate to systems, methods and kiosks for connecting a customer with a person at a remote location having an area of expertise.

### BACKGROUND

In many retail establishments, such as large department stores and large home hardware stores, there are not enough trained order takers to be able to answer customer inquiries in a timely and knowledgeable fashion. As a result, many customers leave these retail establishments in frustration without purchasing anything or they leave with the wrong product or service for their needs. This may result in the customer going elsewhere to purchase the products and services in the future.

Many interactive customer information systems have been developed to address this problem. See for example U.S. Patent Application No. 2006/0190344 (Sang et al.) and U.S. Patent Application No. 2007/0175989 (Auger). In these systems, a kiosk is situated in a retail establishment, such as a store or shopping mall, which enables a customer to establish a two-way audio and video session with a product expert in a remote location when the customer needs assistance.

### SUMMARY

In accordance with this invention, embodiments are provided to enhance the useability of interactive customer information systems and kiosks and/or to enhance the experience of a person who uses same.

Accordingly, in one aspect an interactive customer information system includes a plurality of expert stations, each operable by a person having at least one area of expertise, and at least one kiosk located at a location remote from the plurality of expert stations and comprising a two-way audio and video interface selectively connectable by a customer with an expert station having an area of expertise selected by the customer, the kiosk comprising a visual output module that simultaneously provides two different video images that are viewable by the customer. An advantage of this embodiment is that the experience of a person who uses such a kiosk or system is enhanced since the user is able to continue, e.g., to view the remotely located expert while still being able to view a product demonstration, product literature or an interactive design layout (i.e. a design that is developed on screen by the customer and the person at the expert station using collaborative software).

In another alternate aspect an interactive customer information system provides a document to a customer using a kiosk wherein the document enables the customer to obtain at least one of products and services. The system includes a plurality of expert stations, each station operable by a person having at least one area of expertise, and at least one kiosk located at a location remote from the plurality of expert stations and comprising a two-way audio and video system interface selectively connectable by a customer with an expert station have an area of expertise selected by the customer, and an output device controllable by the selected expert station to output a document based on inquiries made by the customer and/or information provided by the customer, which enables the customer to obtain at least one of products and services. An advantage of this alternate embodiment is that the customer may be provided with a coupon, a form that is at least partially completed and other documents while still being able to interact visually with a person located remotely. The experience of the customer is enhanced by being able to see the expert. Further, the expert is able to immediately provide a personalized document or a document specific to an inquiry by the customer, thereby increasing the useability of the system.

In another alternate aspect, a kiosk for establishing a two-way audio and video session between a customer using the kiosk and person at a remote location is provided. The kiosk includes a customer input module operable by the customer to select a person with a specified expertise at a remote location, a communication module configured to establish a communication link between the customer and the person with the specified expertise, and the communication module comprises a two way audio and video system, and includes a visual output module adapted to simultaneously provide two different video images.

In another alternate aspect, a kiosk for establishing a two-way audio and video session between a customer using the kiosk and person at a remote location is provided. The kiosk includes a customer input module operable by the customer to select a person with a specified expertise at a remote location, a communication module configured to establish a communication link between the customer and the person with the specified expertise, and, an output device adapted to provide a document controllable by the person with the specified expertise wherein the document enables the customer to obtain at least one of products and services.

The embodiments described herein provide in another alternate aspect a method of establishing a two-way audio and video session between a customer using a kiosk and a person at a remote location providing product information. The method includes the following steps: (a) receiving a request from a customer input module of the kiosk for a communication session with a person with a specified expertise type; (b) associating the kiosk with one station of a plurality of remote stations based on the request; (c) establishing a two-way audio and video session between the customer using the kiosk and a person at a station with the specified expertise type; and (d) simultaneously providing at least two distinct visual images to a visual output of the kiosk.

The embodiments described herein provide in another alternate aspect a method of providing a customer using a kiosk with a document enabling the customer to obtain at least one of products and services. The method includes the following steps: (a) receiving a request from a user input module of the kiosk for a communication session with a person with a specified expertise type (b) associating the kiosk with one station of a plurality of remote stations based on the request; (c) establishing a two way audio and video session between the customer using the kiosk and a person with the specified expertise type; and (d) providing at least one document based on inquiries made by the customer during the two way audio and video session wherein the at least one document enables the customer to obtain at least one of products and services.

It will be appreciated that any of the alternate embodiments may be used individually or in any desired combination or sub-combination.

Further aspects and advantages of the embodiments described will appear from the following description taken together with the accompanying drawings.

### BRIEF DESCRIPTION OF THE DRAWINGS

For a better understanding of embodiments of the systems, kiosks and methods described herein, and to show more clearly how they may be carried into effect, reference will be made, by way of example, to the accompanying drawings in which:

FIG. 1 is a block diagram of an interactive customer information system in accordance with at least one embodiment;

FIG. 2 is a block diagram of an embodiment of the kiosk of FIG. 1;

FIG. 3 is a block diagram of an alternative embodiment of the kiosk of FIG. 1;

FIG. 4 is flowchart of a method for establishing a two way audio and video session between a customer using a kiosk and a person at a remote location in accordance with at least one embodiment; and,

FIG. 5 is a flowchart of a method for providing a customer at a kiosk with a document that enables the customer to obtain products and/or services in accordance with at least one embodiment.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

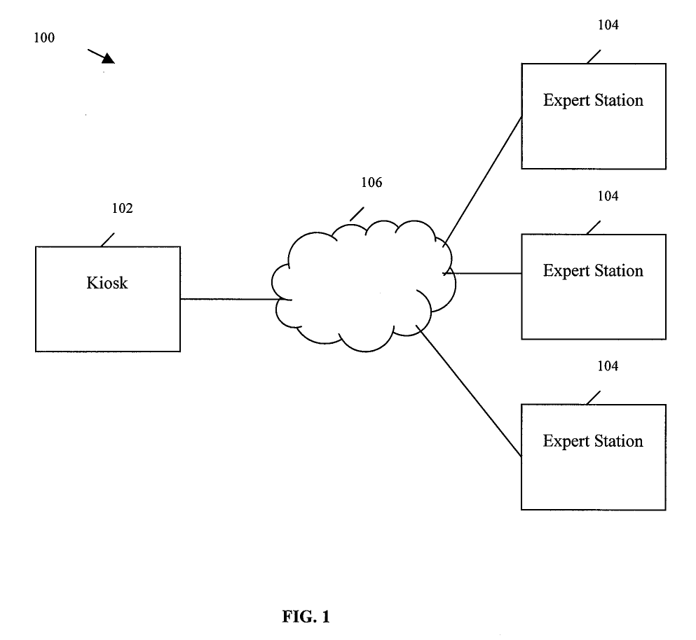

Reference is now made to FIG. 1, in which an interactive customer information system 100 in accordance with an embodiment is illustrated. The interactive customer information system 100 includes a kiosk 102, which is connectable to a plurality of expert stations 104 over a network 106. The kiosk 102 may be located in a variety of locations, such as a store, a shopping mall, a building housing a trade show, a factory, a street corner, an office building or other similar locations where a customer may wish to receive information on a product or service from a live person. Further, kiosk 102 may be set up on a temporary basis at various locations while a store is being renovated, during special events or the like. Although the interactive customer information system 100 is shown with a single kiosk 102, it is recognized that the system 100 may include a plurality of kiosks, each connectable to the plurality of expert stations 104 over the network 106.

The expert stations 104 provide the customer or user with expert information on products and/or services in a one on one interactive manner. By one on one, it is meant that one or more persons may be located at the expert station to provide input to the user and one or more persons may be located at the kiosk to participate in an inquiry to the expert station. In each such case, the kiosk is in communication with a particular expert station, although it is recognized that a kiosk could be connected to two or more expert stations.

Each expert station 104 is remotely located from the kiosk 102 and is operated by a person having at least one area of expertise. Areas of expertise may include expertise on a particular product, line of products, service and/or supplier. For example, one expert station operator may be an expert on drills where another expert station operator may be an expert on all products, or a line or products, made or sold by a company, such as Black & Decker. The service may be, for example, a credit card service whereby, for example, a customer may talk to a representative of a credit card company and a credit card application form may be completed by the expert based on information provided by the customer, or interactively by the customer and the representative and the completed application may be optionally approved by the customer (e.g., the customer signing the application remotely by signing on a screen that sends the signature to the completed application or electronically agreeing that the completed form is accurate by clicking an “I agree” button). In addition to being trained on a particular product, service and/or supplier, each of the persons operating the expert stations 104 may have access to a library of information on a particular product, service or supplier. The library of information may be one or more of a series of reference books, a digital library, one or more websites or databases available over the Internet or an intranet. For example, the library could be a website provided by a manufacturer which is set up for the experts or is accessible by the experts via, e.g., a password.

The network 106 may be any type of communication network such as a public-switched telephone network (PSTN), the Internet, a wireless network (e.g. a cellular network), a private wide area network (WAN) or a private local area network (LAN). Network 106 may use any technology to permit communication between kiosk 102 and the expert stations 104.

In one embodiment the system 100 is used to connect one kiosk 102 to one expert station 104. In this embodiment there is full two-way audio and video communication between the customer or customers using the kiosk 102 and the person or persons at the expert station 104. In an alternative embodiment the system 100 is used to connect a plurality of kiosks 102 to one expert station 104. In an alternative embodiment the system 100 is used to connect a plurality of kiosks 102 to a plurality of expert stations 104. In this embodiment the audio and video of the person or persons at the expert station 104 may be broadcast to all of the connected kiosks 102. When a customer at a kiosk 102 wants to communicate with the person at the expert station 104, the person must submit a request. The request may then put into a queue and the person at the expert station may then select the requests in the queue according to a predetermined method. For example, the person at the expert station 104 may implement a first in first out (FIFO) methodology. This embodiment may be used, for example, as an interactive interview system to broadcast an interview with a famous celebrity. The kiosks 102 would allow customers to not only watch the interview, but to pose questions to the celebrity. For example, the interview may be with a sports celebrity and the kiosks may be located at athletic supply stores.

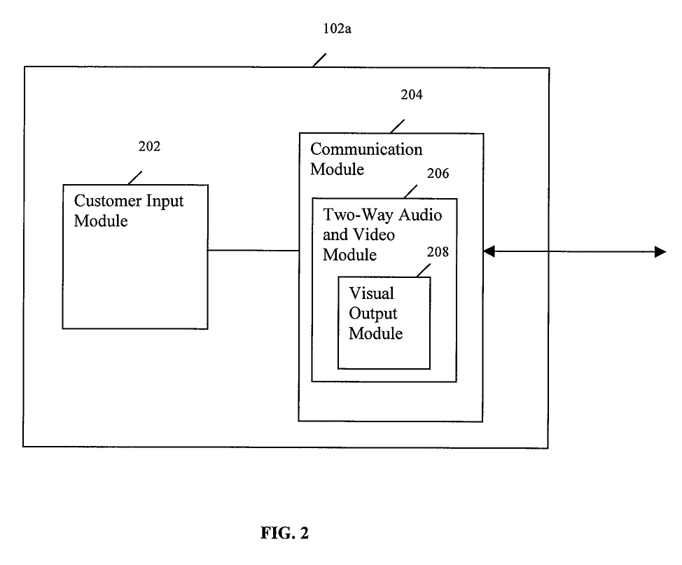

Reference is now made to FIG. 2, in which a block diagram of an embodiment of the kiosk 102 of FIG. 1 is shown. The kiosk 102a of FIG. 2 includes a customer input module 202 and a communication module 204.

The customer input module 202 allows the customer to select the desired characteristics of the person they are going to communicate with. The characteristics may include, for example, the area of expertise of the person, the length of time the person has been an expert in a particular area, the language the person speaks, the gender of the person and the like. In one embodiment the language, gender and time characteristics will be set to a default so that in most cases the user will only have to select the area of expertise.

The customer input module 202 may be implemented as a touch screen that allows the customer to select the expertise criteria through a menu system. Alternatively or in addition, the customer input module 202 may be implemented as a set of pushbuttons where each pushbutton is associated with a particular area of expertise. The user then selects the desired area of expertise by pressing at least one of the pushbuttons. Other suitable customer input modules such as voice/speech recognition systems or mouse and keyboard systems may also be used.

Once a user has selected the expertise criteria using the input module 202 a communication session with a person with the specified criteria may then be initiated. The communication session may be initiated by a user pushing a start button, picking up a telephone handset, and merely selecting the desired expert or any other suitable means. If the user initiates the communication session prior to selecting the expertise criteria a default set of criteria may be used.

The communication module 204 comprises a set of devices, which work together to establish a two-way communication session over the network 106 between the customer using the kiosk 102a and the person at a selected expert station 104. The communication module 204 includes a two-way audio and video system 206 for establishing a two-way audio and video session over the network 106, such as a video teleconference (VTC) session, between the customer using the kiosk 102a and the person at the expert station 104. The two-way audio and video system 206 may support, but is not limited to, any VFC protocol such as H.320, H.323, and H.324.

The two-way audio and video system 206 may include an audio input device (e.g., a microphone) for providing the customer's speech, a visual input device (e.g., a camera) for providing an image, preferably a video image, of the customer, an audio output device (e.g., a speaker) for outputting the speech of the person at the expert station 104, and a visual output module 208.

The two-way audio video system 206 may be configured to provide a private conversation between the customer using the kiosk 102a and the person at the expert station 104. For example, the kiosk 102a may have a telephone handset or headphones and a microphone that acts as both the audio input device and the audio output device. Alternatively, the two-way audio video system 206 may be configured to provide a public conversation between the customer(s) using the kiosk 102a and the person at the expert station. What is meant by public conversation is that people passing by the kiosk can hear and participate in the conversation. For example, the kiosk 102a may have a speaker as the audio output device for broadcasting the speech of the person at the audio station 104, and a microphone as the audio input device for picking up all sounds audible at or near the kiosk 102a. The two-way audio and video system 206 may also be configured to provide either a private conversation or a public conversation and may include means to switch between the two modes.

In one embodiment, the visual output module 208 is used to display for the customer two video images simultaneously. Accordingly, in one embodiment, the first video image may be of the person at the expert station 104 and the second video image may be selected by the person at the expert station 104 based on information or an inquiry received from the customer using the kiosk 102a during the two-way audio and video session.

For example, if the user asks for more information on a particular product, the person at the expert station 104 (the expert) may select an informational or advertising video on the particular product of interest. Similarly, where the user is inquiring on how to use a product or conduct a repair, the person at the expert station 104 may select a video demonstrating how to use or repair the particular product. Another example is when the customer is in a retail store and knows what product they want, but does not know where to locate it. In this situation the person at the expert station 104 may display a map of the store indicating where in the store the particular product is located.

In other embodiments the second video image may be used to interactively review a document or plan. For example, if the customer is inquiring about a service such as a credit card program, the person at the expert station 104 may prompt the customer for information to fill out an application form. The user may provide the requested information verbally to the person at the expert station 104 via the two-way audio and video system 206. The user may also be provided with data input means. For example, the kiosk may further include a physical keyboard or the user may use a touch screen keyboard as, e.g., part of the second video image. Allowing the user the ability to enter at least some of the requested information, e.g. by using collaborative software, through data input is particularly advantageous where, for example, the requested information is sensitive information such as the name of the customer or financial information, the customer has a long name or has a name that is difficult to spell. When all of the information has been retrieved the person at the expert station 104 may display a copy of the completed form as the second video image and the user may have the opportunity to review it and optionally mark it up. Optionally, once the form is completed, the user may click or touch a button that confirms the customer agrees that the completed form is accurate and/or agrees with the specified terms and conditions (e.g., an “I agree” button) or the user may sign a touch screen pad and the signature may be electronically applied to the form. Accordingly, the form may be completed and signed on line without any subsequent action required by a user.

Similarly, for example, if the customer is inquiring about home decorating advice, the person at the expert station 104 may provide as the second video image a layout of a room and the person at the expert station can work with the customer to determine the layout of the furniture in the room. Using collaborative software, the expert and the customer may jointly prepare a plan. Once the plan is complete, the expert may send to the kiosk a list of items that the customer needs to build or produce the design. For example, the customer may receive one or more of a list of items, which are required, the location of the items in the store and the UPC codes for the items.

There are several advantages to maintaining the audio and video session between the customer using the kiosk 102a and the person at the expert station 104 while the second video image is displayed. First, this allows the person at the expert station 104 to add helpful and customer-specific commentary to the video image. Second, the person at the expert station 104 can immediately answer any questions that the customer has about the video image. Third, the person at the expert station 104 can gauge the customer's response to the video image to determine if it does not adequately answer the customer's questions or relate to the customer's inquiries. Fourthly, the customer may feel more connected with the person at the expert station 104 and not feel that they are talking to a computer or avatar.

In one embodiment the visual output module 208 includes two display screens. The two display screens may be placed in any suitable configuration. For example, the two screens may be located side by side or one screen may be placed above the other. In this embodiment one screen displays a video image of the person at the expert station 104 and the other screen displays the video image selected by the person at the expert station 104 in response to inquiries made by the customer using the kiosk 102. Since the second image is preferably selected by the person at the expert station 104, one of the two screens may be blank until the person at the expert station 104 selects a video, or alternatively it may display an advertisement until a video image is selected.

In an alternative embodiment the visual output module 208 comprises one display screen that is operable to display two video images. For example, the display screen may implement what is commonly referred to as “split screen”. Split screen is the visible division of the screen, traditionally in half, but also in several simultaneous images, to simultaneously display a plurality of distinct video images. Alternatively, the display screen may implement “picture in picture” (PiP). PiP is the display of a video image on the full screen at the same time one or more other programs are displayed in inset windows.

The two-way audio and video system 206 may further include recording means for recording the audio and/or video session between the customer and the person at the expert station 104. Such recordings may be used later for verification purposes. For example, where the customer authorizes the person at the expert station 104 to execute a financial transaction, for example, the recording may be used to verify that the customer did provide authorization for the transaction.

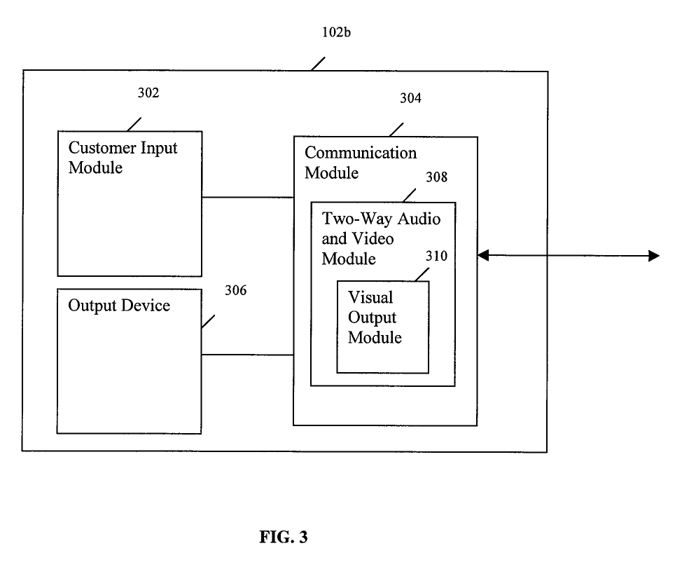

Reference is now made to FIG. 3, in which a block diagram of a second embodiment of the kiosk 102 of FIG. 1 is shown. The kiosk 102b of FIG. 3 includes a customer input module 302, a communication module 304 and an output device 306. The customer input module 302 of FIG. 3 may be equivalent to the customer input module 202 of FIG. 2.

The communication module 304 comprises, e.g., a set of devices, which work together to establish a two-way communication session between the customer using the kiosk 102b and the person at an expert station 104. The communication module 304 may include a two-way audio video module 308.

The two-way audio and video module 308 may include an audio input device (e.g., a microphone) for providing the customer's speech, a visual input device (e.g., a camera or similar device) for providing an image of the customer, an audio output device (e.g., a speaker) for outputting the speech of the person at the expert station 104 and a visual output device 310 (e.g., a display screen) for displaying a video image of the person at the expert station 104. The expert station 104 may include a similar two-way audio and video module. As with the kiosk 102a shown in FIG. 2., the visual output module 310 may optionally be operable to display a second video image simultaneously with the video image of the person at the expert station 104. If so, the second video image is preferably selected by the person at the expert station 104 based on the information received from the customer using the kiosk 102b.

The kiosk 102b also includes an output device 306 for outputting a document, such as a document that can be used by the customer to obtain products and/or services. The type of document and its contents are preferably controlled by the person at the expert station 104. For example, the person at the expert station 104 may select the document type and optionally its contents based on information received from the customer during the two-way audio and video session.

The document may be presented to the user in electronic or hard copy (e.g. paper) form. For example, the output device may be a printer, which prints out a hard copy of the document. The output device may also be a removable storage device such as a memory key, compact disc (CD) or the like which stores an electronic copy of the document.

In one embodiment the document is a coupon that can be used by the customer to obtain a discount on a particular product or set of products. The coupon may be time-limited so that if it is not used within a predetermined amount of time from when the coupon was printed/downloaded, it will expire. The type of products covered by the coupon, the type and/or amount of the discount and the expiry time of the coupon are items that may be controlled by the person at the expert station 104 in response to information received from the customer during the two-way audio and video session. This allows the person at the expert station 104 to tailor the coupon to the customer's specific needs making it more likely that they will use the coupon. This also provides an incentive to customers to use the kiosk 102b.

In an alternative embodiment the document may be an application form that can be used by the customer to enroll in a services program such as a credit card program. The person at the expert station 104 may control the type of application form based on information received from the customer during the two-way audio and video session. The person at the expert station 104 may pre-fill aspects of the form based on information received from the customer. For example, the person at the expert station 104 may fill in the customer's name and personal details for a credit card application. In this case, the person at the expert station 104 cannot complete the application for the customer since the application requires the signature of the customer. Accordingly, the application form is printed at the kiosk where the customer can then sign it. The customer saves time and avoids errors in filling out application forms when a person at an expert station 104 assists them. Further, a user is more likely to return a signed form if most or all of the work to complete the form has been undertaken by a third party, namely the expert.

In another embodiment, in addition to outputting a document that can be used to retain products and/or services, the output device 306 may also be operable to print or otherwise provide a record of any transactions executed by the person at the expert station 104 on behalf of the customer. For example, where the customer authorizes the person at the expert station 104 to order a particular product on the customer's behalf, or to sign the customer up for a particular service, the printed record may be in the form of a receipt.

In a further embodiment, the output device 306 may also be operable to provide the customer with promotional material, such as a flyer. The flyer may be specific to the location of the kiosk 102b (e.g. a specific store) or may be specific to the day or both. In one embodiment, the promotional material may be generated by the output device 306. For example, where the output device 306 is a printer, then the printer may print the promotional material. In other embodiments the output device 306 provides the customer with pre-prepared promotional material that is stored in the kiosk 102b. An advantage of this embodiment is that a store need not have flyers printed commercially by an outside printing company. Instead, the store may design its own flyer and update as required. For example, as a store runs out of stock of a particular item, the flyer may be updated to remove that item. Therefore, a dynamic system is obtained whereby promotional material may be updated daily or several times during a day.

It will be appreciated that an interactive system may use features of either or both kiosks 102a, 102b.

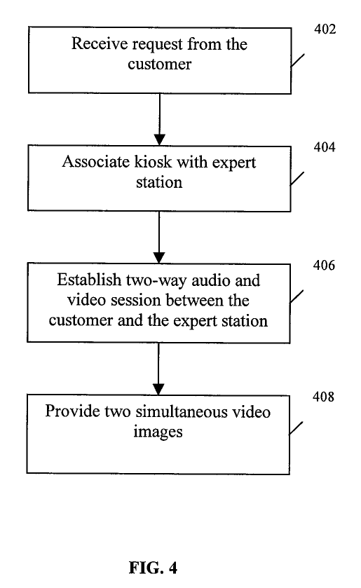

Reference is now made to FIG. 4, in which a flowchart of a method of establishing a two-way audio and video session between a customer using a kiosk and a person at a remote location providing product and/or service information is illustrated. At step 402, the customer at a kiosk 102a makes a request via the customer input module 202 for a communication session with a person with specified characteristics. The specified characteristics may include an area of expertise, the length of time the person has been an expert in the field, the language that they speak and the gender of the person.

At step 404, the kiosk is then associated with one expert station 104 based on the specified characteristics. In one embodiment the interactive customer information system 100 further comprises at least one server (not shown) connected to the network 104. The server includes a database, which may be used to keep track of all of the expert stations 104 in the system 100, the expertise associated with each of the expert stations 104 and their availability. After a user makes a request for a communication session, the kiosk 102a contacts the server and requests a connection with an expert station 104 with the specified characteristics. The server may then determine if there are any available expert stations with the specified characteristics.

If there is an available expert station 104 with the specified characteristics, then the server may associate the expert station 104 with the kiosk 102a. The server may then provide the contact information for the associated expert station 104 to the kiosk 102a. If there is not an available expert station 104 with the specified characteristics, then the server may be configured to notify the kiosk that there are no available experts stations 104 with the specified characteristics. Alternatively, the server may be configured to select an available expert station 104 that has most of the specified characteristics. Alternately, the kiosk may advise the user of the estimated time until a specified expert station is available.

At step 406, a two-way audio and video session is established over the network 106 between the customer using the kiosk 102a and the person at the associated expert station 104.

At step 408, two simultaneous video images are provided to the customer. In one embodiment one video image is a live video image of the person at the expert station 104 and the second video image is controllable by the person at the expert station 104 based on information received from the customer during the two-way audio and video session. The second video image may be an information video on a particular product or service, an instructional video of how to use a product or service, a display of a document for the user to view and/or revise, or an interactive design display (e.g. a floor plan in which the person at the remote station and the customer use to design the layout of furniture in the room).

In one embodiment, once the two-way audio and video session has been established between the customer using the kiosk 102a and the person at the associated expert station 104, a countdown timer starts. If the user does not make a valid customer inquiry within this time the person at the associated expert station 104 may end the two-way audio and video session and/or the session may automatically terminate. The countdown timer may be provided to the user in a separate display (not shown) or may be displayed within the visual output module 208. The time period in which the user must respond may be fixed or may be configurable by the person at the expert station 104.

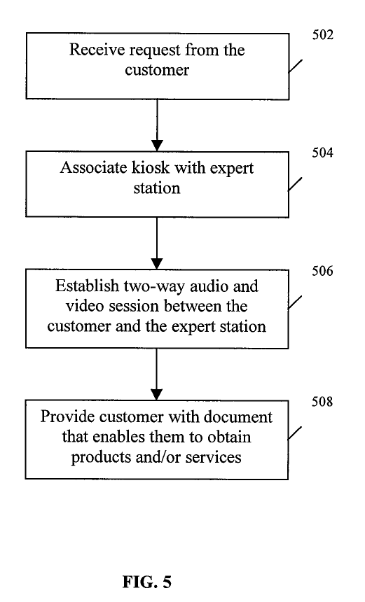

Reference is now made to FIG. 5, in which a flowchart of a method for providing a customer using a kiosk with a document that enables them to obtain products and/or services is illustrated. At step 502, the customer at a kiosk 102b makes a request via the customer input module 302 for a communication session with a person with specified characteristics.

At step 504, the kiosk 102b is associated with one expert station 104 based on the specified characteristics by any means known in the art. For example, the kiosk 102b may be associated with an expert station 104 using a server as described above in relation to FIG. 4. At step 506, a two-way audio and video session is established over the network 106 between the customer using the kiosk and the person at the associated expert station 104. During the session, the user will seek information that may be supplied by the expert. During the session, or thereafter, the customer is provided with a document that can be used to obtain products and/or services (step 508).

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. An interactive customer information system comprising:
a) a plurality of expert stations, each station operable by a person having at least one area of expertise; and,
b) at least one kiosk located at a location remote from the plurality of expert stations and comprising a two-way audio and video interface selectively connectable by a customer with an expert station having an area of expertise selected by the customer, the kiosk comprising a visual output module that simultaneously provides two different video images that are viewable by the customer.

2. The interactive customer information system of claim 1 wherein the visual output module comprises two video screens.

3. The interactive customer information system of claim 2 wherein the visual output module is adapted to simultaneously provide an image of a person at the expert station selected by the customer and an image of a product or method of using a product.

4. The interactive customer information system of claim 1 wherein at least some of the expert stations include an interface with a library of product information.

5. The interactive customer information system of claim 1 wherein the kiosk further comprises an output module adapted to provide a document relating to an inquiry made by the customer.

6. The interactive customer information system of claim 1 wherein at least some information in the document is inputted by one of the person at the expert station having the area of expertise selected by the customer.

7. The interactive customer information system of claim 5 wherein the document is a product coupon.

8. The interactive customer information system of claim 7 wherein the product coupon is valid for a limited time from its output from the kiosk.

9. The interactive customer information system of claim 8 wherein the output module is a printer.

10. An interactive customer information system for providing a document to a customer using a kiosk which enables the customer to obtain at least one of products and services, the system comprising:
a) a plurality of expert stations, each station operable by a person having at least one area of expertise; and,
b) at least one kiosk located at a location remote from the plurality of expert stations and comprising a two-way audio and video system interface selectively connectable by a customer with an expert station have an area of expertise selected by the customer, and an output device controllable by the selected expert station to output the document based on inquiries made by the customer.

11. The interactive customer information system of claim 10 wherein the data output device is a printer.

12. The interactive customer information system of claim 10 wherein the data output device is a removeable storage device.

13. The interactive customer information system of claim 10 wherein the document is a product coupon.

14. The interactive customer information system of claim 13 wherein the product coupon is valid for a limited time from its output from the kiosk.

15. A kiosk for establishing a two-way audio and video session between a customer using the kiosk and person at a remote location, the kiosk comprising:
a) a customer input module operable by the customer to select a person with a specified expertise at a remote location;
b) a communication module configured to establish a communication link between the customer and the person with the specified expertise; and
c) the communication module comprising a two-way audio and video system, and including a visual output module adapted to simultaneously provide two different video images.

16. The kiosk of claim 15 wherein the visual output module includes a first display screen and a second display screen, whereby a video image of the person with the specified expertise is viewable on the first display screen and an image of a product or a method of using a product is viewable on the second display screen.

17. The kiosk of claim 15 wherein the visual output includes a split screen display whereby a video image of the expert is viewable on a first side of the split screen display and an image of a product or a method of using a product is viewable on a second side of the split screen display.

18. The kiosk of claim 15 further comprising an output device adapted to provide a document which enables the customer to obtain at least one of products and services.

19. The kiosk of claim 18 wherein the output device is a printer.

20. The kiosk of claim 17 wherein the output device is controllable by the person with the specified expertise whereby at least some of the content of the document is controllable by the person with the specified expertise.

21. A kiosk for establishing a two-way audio and video session between a customer using the kiosk and person at a remote location, the kiosk comprising:
a) a customer input module operable by the customer to select a person with a specified expertise at a remote location;
b) a communication module configured to establish a communication link between the customer and the person with the specified expertise; and,
c) output device adapted to provide a document controllable by the person with the specified expertise wherein the document enables the customer to obtain at least one of products and services.

22. The kiosk of claim 21 wherein the data output device is a printer.

23. The kiosk of claim 21 wherein the output device is controllable by the person with the specified expertise whereby at least some of the content of the document is controllable by the person with the specified expertise.

24. The kiosk of claim 21 wherein the communication module comprises a two-way audio and video system, and including a visual output module adapted to simultaneously provide two different video images.

25. The kiosk of claim 24 wherein the visual output module includes a first display screen and a second display screen, whereby a video image of the person with the specified expertise is viewable on the first display screen and an image of a product or a method of using a product is viewable on the second display screen.

26. The kiosk of claim 24 wherein the visual output includes a split screen display whereby a video image of the expert is viewable on a first side of the split screen display and an image of a product or a method of using a product is viewable on a second side of the split screen display.

27. The kiosk of claim 21 wherein the document is a product coupon.

28. A method of establishing a two-way audio and video session between a customer using a kiosk and a person at a remote location providing product information, the method comprising the steps:
a) receiving a request from a customer input module of the kiosk for a communication session with a person with a specified expertise type;
b) associating the kiosk with one station of a plurality of remote stations based on the request;
c) establishing a two-way audio and video session between the customer using the kiosk and a person at a station with the specified expertise type; and,
d) simultaneously providing at least two distinct visual images to a visual output of the kiosk.

29. The method of claim 28 wherein one of the visual images is live video of the person with a specified expertise type and the other is an image of a product or a method of using a product.

30. The method of claim 28 wherein one of the visual images is selected by the person with the specified expertise type based on inquiries made by the customer during the two-way audio and video session.

31. The method of claim 28 further comprising generating at least one document based on inquiries made by the customer during the two-way audio and video session wherein the document enables the customer to obtain at least one of products and services.

32. A method of providing a customer using a kiosk with a document enabling the customer to obtain at least one of products and services, the method comprising the steps:
a) receiving a request from a user input module of the kiosk for a communication session with a person with a specified expertise type;
b) associating the kiosk with one station of a plurality of remote stations based on the request;
c) establishing a two way audio and video session between the customer using the kiosk and a person with the specified expertise type; and
d) providing at least one document based on inquiries made by the customer during the two way audio and video session wherein the at least one document enables the customer to obtain at least one of products and services.

33. The method of claim 32 wherein the at least one document is a product coupon.

34. The method of claim 33 wherein the product coupon is valid for a period of time that commences at the time of the session.
